(19) United States
(12) Patent Application Publication
(10) Pub. No.: US 2011/0154448 A1
(43) Pub. Date: Jun. 23, 2011

(54) SERVER, CLIENT, LICENSE MANAGEMENT SYSTEM, AND LICENSE MANAGEMENT METHOD

(75) Inventors: Atsushi Oida, Osaka (JP); Hiroyuki Wada, Kyoto (JP)

(73) Assignee: PANASONIC CORPORATION, Osaka (JP)

(21) Appl. No.: 13/038,032

(22) Filed: Mar. 1, 2011

Related U.S. Application Data
(63) Continuation of application No. PCT/JP2009/003680, filed on Aug. 3, 2009.

(30) Foreign Application Priority Data
Sep. 2, 2008 (JP) 2008-224317

(51) Int. Cl. G06F 21/00

(52) U.S. Cl. 726/4

(57) ABSTRACT

A server carries out a network position check process for a client which requests to use a content, and the server generates a vicinity check information including a requirement for authorizing omission of the network position check process for the client when the client thereafter requests to use the content again after the network position check process determines that the client is located in a local area network where the server belongs. At least one of the server and the client retains the vicinity check information to determine based on the vicinity check information whether the network position check process can be omitted when the client thereafter requests to use the content again.

### FIELD OF THE INVENTION

The present invention relates to a license management system for management of availability of a copyright-protected content, and a server, a client, and a license management method used in the license management system.

### BACKGROUND OF THE INVENTION

The entire documents of Japanese patent application No. 2008-224317 filed on Sep. 2, 2008, which include the specification, drawings, and scope of claims, are incorporated herein by reference.

A system was made available in recent years, wherein a content of a digital copyright work, for example, music, video images and games, is distributed through the Internet or digital broadcasting. Another recent trend is a small local area network, generally called a home network, which is increasingly widespread among users as home-use network, wherein a computer and household electric appliances such as a television receiver and a video reproducer are network-connected to enable inter-device communication. The local area network is often interconnected with an external broadband network such as the Interne by way of a router. Any authorized content acquired through the Internet is stored in a server of the local area network and then distributed to other client in the household through the local area network so that the client can view or listen to the content.

The content thus stored in the server is often a private content or a paid content to be copyright-protected. The local area network interconnected with an external network by way of a router should be able to block any unauthorized access by an unknown third party who does not have a right to use (unlicensed party) such a content.

The Digital Right Management (DRM) was introduced to prevent illegal duplication or reuse of the content by a third party. The DRM provides generally called domain management, wherein all of devices in the local area network are handled as being included in a domain so that the devices in the same domain can share the content to be copyright-protected.

When any content covered by the domain management is reproduced, it has to be confirmed whether a reproduction device is located in the local area network, in other words, whether the device is covered by via-router network management in the local area network. Conventionally, vicinity check, for example, is employed to check the location. In the vicinity check, it is determined that the server and the client are located in the same local area network when a length of response time for an invocation request from the server to the client is shorter than a predefined length of time.

In the Cited Document 1, it is determined that a server which distributes a content and a client which accesses and uses the content are located in the same local area network depending on whether the server and the client can similarly access a physical medium in a short length of time.

### Prior Art Document

### Patent Document

Patent Document 1: Unexamined Japanese Patent Applications Laid-Open No. 2004-334756

### SUMMARY OF THE INVENTION

### Problem to be Solved by the Invention

It is an effective technical approach for any devices immobilized in the local area network to determine that the client and the server are in the same local area network, more specifically in the same domain, when the access time is short as disclosed in the Cited Document 1.

Employing the technique in a mobile device such as laptop computer or PDA, however, the vicinity check fails when the mobile device is temporarily carried out of the local area network, for example, when a user goes out with the mobile device to somewhere uncovered by the via-router network management. Thus, the user is unable to access any content or license of the server in his own domain when he is out.

The present invention was carried out to deal with the conventional disadvantage, and aimed at enabling a user to access and use any content and license of a server which belongs to his domain from anywhere outside the local area network.

### Means for Solving the Problem

1) A license management system according to an aspect of the present invention is a license management system characterized in that a server supplies a client with a content and a license including a requirement for use of the content correspondingly with a request to use the content transmitted from the client through a communication line, wherein

the server carries out a network position check process for the client which requests to use the content, and the server generates a vicinity check information including a requirement for authorizing omission of the network position check process for the client when the client thereafter requests to use the content again after the network position check process determines that the client is located in a local area network where the server belongs, and

at least one of the server and the client retains the vicinity check information to determine based on the vicinity check information whether the network position check process can be omitted when the client thereafter requests to use the content again.

The network position is checked by, for example, determining whether a length of response time to an invocation request from the server to the client is shorter than a predefined length of time. The present invention preferably carries out a license availability check for the client in addition to the network position check process.

The vicinity check information preferably includes a requirement for authorizing omission of the network position check process after the network position check process determines that the client is located in the local area network where the server belongs.

An example of the requirement when the vicinity check information is retained by the server is an information for identifying the client which is already supplied with the content and the license after the network position check process determines that the client is located in the local area network where the server belongs. An example of the requirement when the vicinity check information is retained by the client is time-related information such as a duration of time when the network position check process can be omitted.

According to the present invention, the requested content and license are preferably supplied to and used by the client when the omission of the network position check process is determined based on the vicinity check information after the vicinity check information is retained by the server. According to the present invention, the content and the license already supplied to the client can be used by the client when the omission of the network position check process is determined based on the vicinity check information after the vicinity check information is retained by the client.

According to the license management system provided by the present invention, when the network position check process determines that the server and the client are in the same local area network, the server generates the vicinity check information, and the server or the client retains the generated vicinity check information. Since the information is thus retained, the network position check process can be omitted as far as the requirement included in the vicinity check information is met in any access thereafter made by the client. According to the license management system thus technically characterized, when a user goes out with the client to somewhere outside the local area network, he is still able to use any content and license covered by the domain management which are newly supplied from the server to the client, or any content and license covered by the domain management which are already stored in the client.

2) A license management system according to another aspect of the present invention is a license management system characterized in that a server supplies a client with a content and a license including a requirement for use of the content correspondingly with a request to use the content transmitted from the client through a communication line, wherein

the server carries out a network position check process for the client which requests to use the content, and the server supplies the client with the content, the license, and a vicinity check information including a requirement for authorizing omission of the network position check process for the client when the client thereafter requests to use the content again after the network position check process determines that the client is located in a local area network where the server belongs, and

the client retains the vicinity check information, the content, and the license, and determines based on the vicinity check information whether the network position check process can be omitted to use the content when the client thereafter requests to use the content again.

The vicinity check information preferably includes a requirement for authorizing omission of the network position check process after the network position check process determines that the client is located in the local area network where the server belongs, and the requirement includes a time-related information such as a duration of time when the network position check process can be omitted. The client may immediately retain the received vicinity check information or may process the vicinity check information before the retention.

According to the license management system provided by the present invention, when the network position check process determines that the server and the client are in the same local area network, the server generates the vicinity check information, and the server or the client retains the generated vicinity check information. Since the information is thus retained, the network position check process can be omitted as far as the requirement included in the vicinity check information is met in any access to the server thereafter made by the client. According to the license management system thus technically characterized, when a user goes out with the client to somewhere outside the local area network, he is still able to use any content and license covered by the domain management which are newly supplied from the server to the client, or any content and license covered by the domain management which are already stored in the client.

3) A license management system according to another aspect of the present invention is a license management system characterized in that a server supplies a client with a content and a license including a requirement for use of the content correspondingly with a request to use the content transmitted from the client through a communication line, wherein

the server carries out a network position check process for the client which requests to use the content, and the server supplies the client with the content and the license, and further generates and retains a vicinity check information including a requirement for authorizing omission of the network position check process for the client when the client thereafter requests to use the content again after the network position check process determines that the client is located in a local area network where the server belongs, and

the server determines based on the vicinity check information whether the network position check process can be omitted to supply the client with the content and the license when the client thereafter requests to use the content again.

The vicinity check information includes a requirement for authorizing omission of the network position check process after the network position check process determines that the client is located in the local area network where the server belongs. The requirement includes an information for identifying the client which is already supplied with the content and the license after the network position check process determines that the client is located in the local area network where the server belongs.

According to the license management system provided by the present invention, when the network position check process determines that the server and the client are in the same local area network, the server generates and retains the vicinity check information. Since the information is thus retained, the network position check process can be omitted as far as the requirement included in the vicinity check information is met in any access thereafter made by the client. According to the license management system thus technically characterized, when a user goes out with the client to somewhere outside the local area network, any content and license covered by the domain management can be supplied to and used by the client.

4) A client according to an aspect of the present invention is a client used in a license management system characterized in that a server supplies a client with a content and a license including a requirement for use of the content correspondingly with a request to use the content transmitted from the client through a communication line, wherein the server carries out a network position check process for the client which requests to use the content, and the server supplies the client with the content, the license, and a vicinity check information including a requirement for authorizing omission of the network position check process for the client when the client thereafter requests to use the content again after the network position check process determines that the client is located in a local area network where the server belongs,

the client comprising:

a memory for storing the content;

a license management unit for retaining the license; and

a vicinity check information management unit for retaining the vicinity check information, and

the vicinity check information management unit determines based on the vicinity check information whether the network position check process can be omitted to use the content when the client thereafter requests to use the content again.

According to the client provided by the present invention, when the network position check process determines that the server and the client are in the same local area network, the server supplies the client with the content, license, and vicinity check information to be retained by the client. Since the information is thus retained, the network position check process can be omitted to use the content and the license as far as the requirement included in the vicinity check information is met in any access to the server thereafter made by the client. According to the client thus technically characterized, any content and license covered by the domain management which are already stored in the client can be used by the client after a user goes out with the client to somewhere outside the local area network.

5) In the client according to the present invention, the vicinity check information management unit preferably receives a latest vicinity check information by accessing the server on regular intervals to update the vicinity check information with the latest information. In the case where the requirement included in the vicinity check information is a time-related requirement, the time-related requirement is possibly no longer met when the user is out with the client. Therefore, it is desirable to retain the latest vicinity check information obtained while the client is still in the local area network. According to the client thus technically characterized, when the server and the client currently located in the same local area network communicate with each other on regular intervals, the vicinity check information can be constantly updated so that the latest vicinity check information can always be retained in the client.

6) In the client according to the present invention, the vicinity check information preferably includes a time-related information for specifying a time point when the client which requests to use the content is determined as being located in the local area network where the server belongs.

According to the client provided by the present invention, the time-related information included in the vicinity check information retained by the client can impose a restriction on a duration of time when any content or relevant license covered by the domain management is available when the client is located somewhere outside the local area network. This technical characteristic can improve user-friendliness of the client which may be temporarily carried out of the local area network while ensuring copyright protection.

7) The client recited in 6) preferably further comprises a measuring instrument for measuring time, wherein the time-related information is an information of network position check omission time length indicative of a length of time when the network position check process can be thereafter omitted, and the vicinity check information management unit calculates an information of network position check omission time limit indicative of a time limit by which the omission of the network position check process is thereafter authorized to use at least one of the content and the license based on a measured value obtained by the measuring instrument and the information of network position check omission time length.

The information of network position check omission time length is more specifically a length of time when the network position check process can be omitted, for example, 24 hours. The measuring instrument may count passing time or number of clocks. The vicinity check information management unit may add the information of network position check omission time length (length of time when the network position check process can be omitted) to a current time or number of clocks counted by the measuring instrument to calculate the information of network position check omission time limit (time limit by which the omission of the network position check process is thereafter authorized).

The information of network position check omission time length indicative of the length of time when the network position check process can be omitted is received from the server. The received information of network position check omission time length is added to the measured value obtained by the measuring instrument of the client, and the resulting information is managed as the information of network position check omission time limit (time limit by which the omission of the network position check process is thereafter authorized). This technical characteristic can impose a restriction on a length of time when any content or relevant license can be used by the client without measuring and managing time on the server side.

8) The client recited in 6) preferably further comprises a time-related information management unit in charge of time management in synchronization with a time-related information management unit of the server, wherein

the time-related information is a start time and an end time of a duration of time when the network position check process can be thereafter omitted, and

the vicinity check information management unit omits the network position check process to use at least one of the content and the license in the duration of time from the start time till the end time managed by the time-related information management unit.

This technical characteristic can arbitrarily set the duration of time when the network position check process can be omitted to use the content.

9) The client according to the present invention preferably communicates with a plurality of the servers, wherein

the vicinity check information includes an information for identifying any of the servers which carries out the network position check process as a requirement for determining whether the network position check process can be thereafter omitted.

According to the client provided by the present invention, when the client interacts with a plurality of servers for the network position check process to be granted any content or relevant license, the requirement for determining whether the network position check process can be thereafter omitted can be set by each of the servers.

10) The client according to the present invention preferably communicates with a plurality of the servers, wherein

the vicinity check information includes an information for identifying a domain in the local area network where the server which carries out the network position check process belongs as a requirement for determining whether the network position check process can be thereafter omitted.

According to the client provided by the present invention, the requirement for determining whether the network position check process can be thereafter omitted can be set per domain. When the client interacts with a plurality of servers in the same domain for the network position information, the vicinity check information can be updated through an access to one of the plurality of servers.

11) In the client according to the present invention, the vicinity check information preferably includes an information for identifying the content as a requirement for determining whether the network position check process can be thereafter omitted. According to the client provided by the present invention, the requirement for determining whether the network position check process can be thereafter omitted can be set per content

12) In the client according to the present invention, the vicinity check information preferably includes an information for identifying a user who owns the content as a requirement for determining whether the network position check process can be thereafter omitted. According to the client provided by the present invention, the requirement for determining whether the network position check process can be thereafter omitted can be set per content owner. For example, the network position check process omission time length set in a content owned by the user himself is longer than the time length set in any other content owned by his family member.

13) In the client according to the present invention, the vicinity check information preferably includes an information for setting an availability restriction for at least one of the content and the license as a requirement for determining whether the network position check process can be thereafter omitted.

According to the client provided by the present invention, number of times in total when the network position check process can be thereafter omitted can be set as a requirement for determining whether the network position check process can be thereafter omitted.

14) The client according to the present invention preferably includes a plurality of the clients, wherein when a first client which is one of the plurality of clients confirms correspondingly with an access made by a second client which is the other of the plurality of clients that the second client is located in a local area network where the first client is connected, the first client supplies the second client with the vicinity check information retained by the first client.

According to the client provided by the present invention, the clients currently not located in the same local area network can interact with each other to update the vicinity check information without being reconnected to the server.

15) In the client according to the present invention, the server preferably checks whether the client is located in the local area network where the server belongs and whether the license is available to the client correspondingly with the vicinity check information and a request to update the license transmitted from the client, and the server supplies the client with the vicinity check information and an updated information of the license after the network position check process determines that the client is located in the local area network where the server belongs and the license is available to the client, and

the client updates the vicinity check information retained by the vicinity check information management unit and the license retained by the license management unit based on the updated information.

According to the client provided by the present invention, when the server and the client are mutually authenticated again, the vicinity check information and the license are updated, and any content already transferred to the client is activated in place of retransmitting the content so that the communication traffic is reduced.

16) In the client recited in 15), it is preferable that the server request the client to deactivate any license and relevant content whenever the confirmation of the license availability fails, and the client deactivates the license and the content based on the request.

According to the client provided by the present invention, when the server and the client are mutually authenticated again and the confirmation of the license availability fails, in other words, in the case where the client has any content and relevant license already deleted from the server, the content and the license are deleted from the client as well so that any content already deleted from the server is unavailable to the client.

17) A server according to an aspect of the present invention carries out a network position check process for a client which transmits a request to use a content through a communication line to determine whether the client is located in a local area network where the server belongs, and

the server supplies the client with the content, a license including a requirement for use of the content, and a vicinity check information including a requirement for authorizing omission of the network position check process for the client when the client thereafter requests to use the content again after the network position check process determines that the client is located in the local area network.

18) According to the server provided by the present invention, when the network position check process determines that the server and the client are located in the same local area network, the server supplies the client with the content, license, and vicinity check information so that the client retains the supplied content, license, and information. The client is able to use the content and the license without the network position check process as far as the requirement included in the vicinity check information is met in any access thereafter made by the client. When the client is carried out of the local area network, any content and license covered by the domain management which are stored in the client can be used by the client.

18) server according to another aspect of the present invention carries out a network position check process for a client which transmits a request to use a content through a communication line, and supplies the client with the content and a license including a requirement for use of the content after the network position check process determines that the client is located in a local area network where the server belongs,

the server further comprising a vicinity check information management unit for retaining a vicinity check information indicative of a client already supplied with the content and the license, and

the vicinity check information management unit determines based on the vicinity check information whether the client which requests to use the content is the client already supplied with the content and the license, and the vicinity check information management unit omits the network position check process for the client after determining that the client which requests to use the content is the client already supplied with the content and the license.

According to the server provided by the present invention, the vicinity check information indicative of the client already supplied with the content and the license (for example, client name) is retained by the server after the network position check process determines that the client and the server are located in the same local area network. When the client is currently located outside and can only access the server through a network other than the local real network, the server can still omit the network position check process to supply the content and the license to the client.

19) In the server according to the present invention, the vicinity check information preferably includes time-related information for specifying a time point when the client requesting to use the content is determined as being located in the local area network where the server belongs.

According to the server provided by the present invention, the vicinity check information retained by the server includes the time-related information given at the time of the network position check process which determined that the client and the server are located in the same local area network. Therefore, a length of time when the network position check process is omitted can be set based on the time-related information.

20) A license management method according to the present invention, comprises the following steps wherein:

a server carries out a network position check process for a client which transmits a request to use a content through a communication line to determine whether the client is located in a local area network where the server belongs;

the server supplies the client with the content, a license, and a vicinity check information including a requirement for authorizing omission of the network position check process for the client when the client thereafter requests to use the content again after the server determines that the client is located in the local area network;

the client retains the content, the license, and the vicinity check information and

the client determines based on the vicinity check information whether the network position check process can be omitted to use the content when the client thereafter requests to use the content again.

According to the license management method provided by the present invention, when the network position check process determines that the server and the client are located in the same local area network, the server generates the vicinity check information and makes the client retain the generated information therein. Since the information is thus retained, the network position check process can be omitted as far as the requirement included in the vicinity check information is met in any access thereafter made by the client. When a user goes out with the client to somewhere outside the local area network, he is still able to use any content and license covered by the domain management which are already stored in the client.

### EFFECT OF THE INVENTION

According to the present invention, when the network position check process performed between the server and the client determines that the server and the client are located in the same local area network, the server generates the vicinity check information including the requirement for authorizing omission of the network position check process in any access thereafter made by the client, and the server or the client retains the generated information. Since the vicinity check information is thus retained, the network position check process can be omitted as far as the requirement included in the vicinity check information is met in any access thereafter made by the client. According to the license management system, when a user goes out with the client to somewhere outside the local area network, he is still able to use any content and license covered by the domain management which are newly supplied from the server to the client, or any content and license covered by the domain management which are already stored in the client.

### BRIEF DESCRIPTION OF THE DRAWINGS

FIG. 1 is drawing of a home network including a server and a client according to an exemplary embodiment 1 of the present invention.

FIG. 2 is a block diagram illustrating main structural elements of the server and the client according to the exemplary embodiment 1.

FIG. 3 is a flow chart illustrating processing steps for license management according to the exemplary embodiment 1.

FIG. 4 is a processing flow of a vicinity check information associated with the license management according to the exemplary embodiment 1.

FIG. 5 is a flow chart illustrating processing steps for license management according to the exemplary embodiment 1.

FIG. 6 illustrates specific examples of the vicinity check information according to a modified embodiment of the present invention.

FIG. 7 is a block diagram illustrating main structural elements of a server and a client according to an exemplary embodiment 2 of the present invention.

FIG. 8 is a processing flow of a vicinity check information associated with license management according to the exemplary embodiment 2.

FIG. 9 is a block diagram illustrating main structural elements of a server and a client according to an exemplary embodiment 3 of the present invention.

FIG. 10 is a block diagram illustrating main structural elements of a server and a client according to an exemplary embodiment 4 of the present invention.

FIG. 11 is a flow chart illustrating processing steps for license management according to the exemplary embodiment 4.

FIG. 12 is a block diagram illustrating main structural elements of a server and a client according to an exemplary embodiment 5 of the present invention.

FIG. 13 is a flow chart illustrating processing steps for license management according to the exemplary embodiment 5.

### EXEMPLARY EMBODIMENTS FOR CARRYING OUT THE INVENTION

Hereinafter, exemplary embodiments of a license management system according to the present invention are described in detail referring to the accompanied drawings.

### Exemplary Embodiment 1

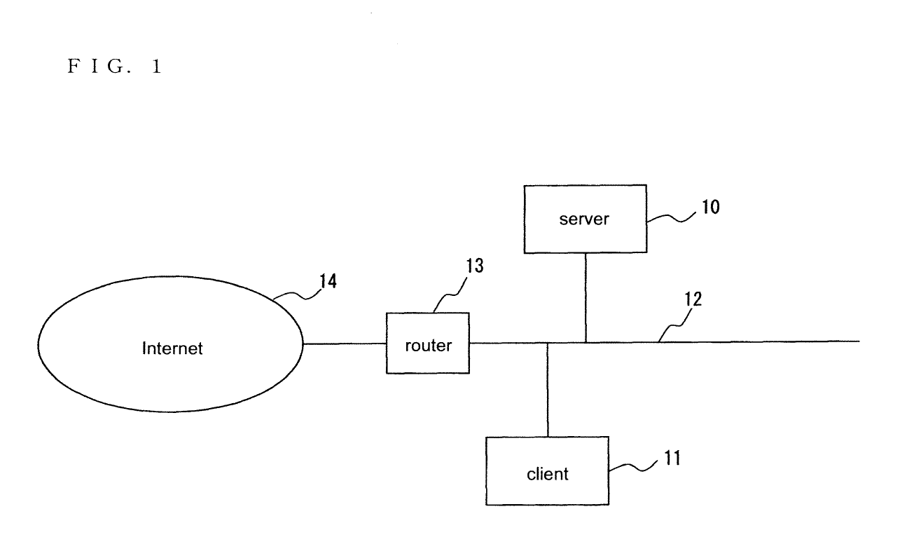

FIG. 1 illustrates a basic structure of a local area network 12 including a server 10 and a client 11 according to an exemplary embodiment 1 of the present invention. The local area network 12 is a home network laid in a relatively small area such as an individual residence. The local area network 12 is connected to an external network such as Internet 14 by way of a router 13. The local area network 12 is connected to the server 10 and the client 11 constituting the license management system. The server 10 stores therein an authorized content acquired via the Internet 14. In response to a request to use the content received from the client 11, the server 10 supplies the client 11 with the content and license as described later. The client 11 according to the present exemplary embodiment is a mobile device such a laptop computer or PDA (mobile information terminal) that can be carried out of the local area network 12. In FIG. 1, the client 11 is currently located in the local area network 12.

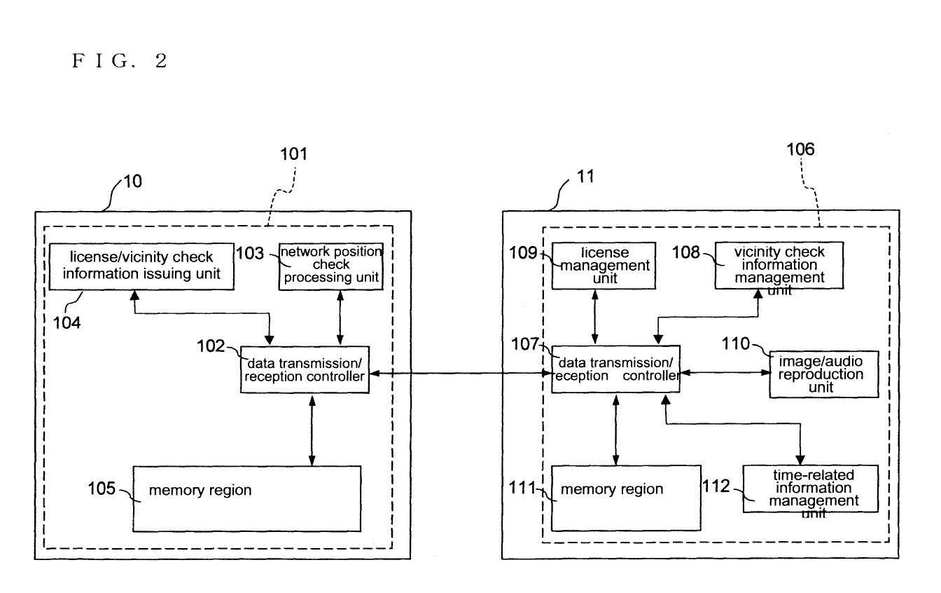

FIG. 2 is a block diagram illustrating main structural elements for license management in the server 10 and the client 11. The server 10 and the client 11 respectively comprise a server-side license management device 101 and a client-side license management device 106. The server-side license management device 101 transmits and receives control information to and from the client-side license management device 106. The server-side license management device 101 comprises a data transmission/reception controller 102, a network position check processing unit 103, a license/vicinity check information issuing unit 104, and a memory region 105. The data transmission/reception controller 102 outputs a vicinity check information described later, content, and license. The network position check processing unit 103 carries out a network position check process with respect to the client-side license management device 106 to check whether the client 11 is located in a local area network where the server 10 belongs. The license/vicinity check information issuing unit 104 issues the vicinity check information and the license for the client-side license management device 106 after the validity of the client 11 is confirmed. The content is stored in the memory region 105.

The client-side license management device 106 comprises a data transmission/reception controller 107, a vicinity check information management unit 108, a license management unit 109, a timer, a time-related information management unit 112, an image/audio reproduction unit 110, and a memory region 111. The data transmission/reception controller 107 transmits and receives control information to and from the server-side license management device 101, and also inputs therein the vicinity check information, content, and license. The vicinity check information management unit 108 processes the vicinity check information issued by the license/vicinity check information issuing unit 104 and stores the processed information therein as described later. The license management unit 109 manages the license issued by the license/vicinity check information issuing unit 104. The timer is a measuring instrument in which a counter value is incremented per a given cycle. The time-related information management unit 112 supplies a current value of the timer whenever requested by the other structural elements. The image/audio reproduction unit 110 reproduces the content after confirming that the license is available and the client 11 is located in the local area network where the server 10 belongs. The content supplied from the server 10 is stored in the memory region 111.

Next are described main functions of the structural elements provided in the server-side license management device 101 and the client-side license management device 106 illustrated in FIG. 2. The data transmission/reception controller 102 of the server-side license management device 101 is connected to the data transmission/reception controller 107 of the client-side license management device 106 to carry out authentication processes and data transmission and reception to transmit and receive the content covered by domain management among the respective devices. The communication between the data transmission/reception controller 102 and the data transmission/reception controller 107 may be encrypted to improve a level of security. When a request to use the content is received from the client-side license management device 106, the network position check processing unit 103 of the server-side license management device 101 carries out a network position check process and determines the processing result to determine whether the client 11 and the server 10 are located in the same local area network. It is determined in the network position check process that the server 10 and the client 11 are located in the same local area network when, for example, a length of response time for an invocation request from the server 10 to the client 11 is shorter than a predefined length of time.

The license/vicinity check information issuing unit 104 of the server-side license management device 101 generates the license and the vicinity check information to be supplied to the client-side license management device 106 depending on the results of the network position check process and the license availability. The vicinity check information management unit 108 of the client-side license management device 106 processes and stores therein the vicinity check information supplied from the license/vicinity check information issuing unit 104 of the server-side license management device 101 as described below, and confirms whether a requirement included in the stored vicinity check information is met, in other words, verifies the validity of the vicinity check when the content is used. The license management unit 109 of the client-side license management device 106 stores therein the license supplied from the license/vicinity check information issuing unit 104 of the server-side license management device 101 and confirms whether the stored license is available when the content is used.

A single chip LSI may constitute the data transmission/reception controller 102, network position check processing unit 103, license/vicinity check information issuing unit 104, data transmission/reception controller 107, vicinity check information management unit 108, license management unit 109, and image/audio reproduction unit 110.

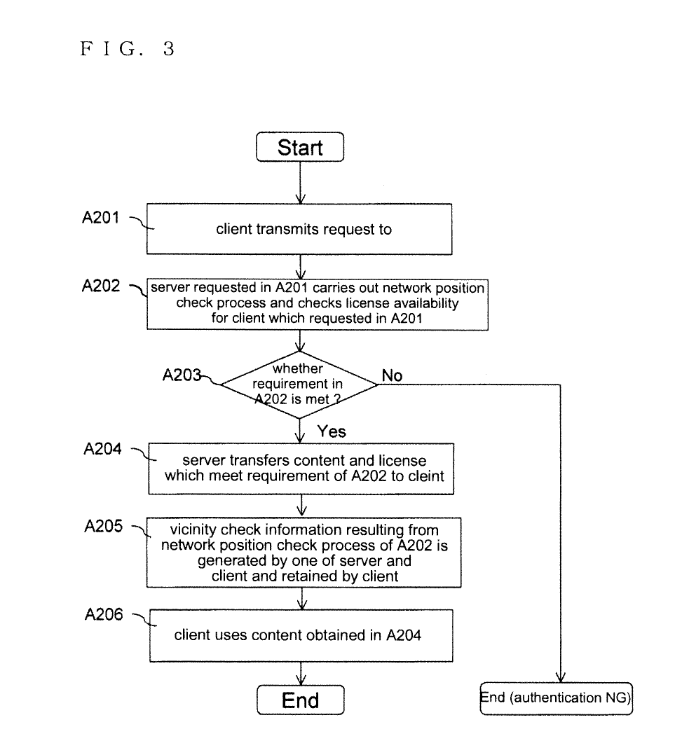

FIG. 3 is a processing flow of the license management system according to the exemplary embodiment 1 when the client 11 accesses the server 10 for the first time. The client-side license management device 106 transmits a request for use of the content to the server-side license management device 101 (Step A201). The server-side license management device 101 which received the request carries out the network position check process to determine whether the client 11 is located in the local area network 12 where the server 10 belongs. The server-side license management device 101 further determines whether the client 11 and the server 10 both belong to the same domain and whether the license is available (Step A202).

When the result of Step A202 is NG, meaning that the network position check process for the client 11 which requested to use the content failed to determine that the client 11 and the server 10 are located in the same local area network or the license of the client 11 is determined as unavailable, the server-side license management device 101 sends an authentication NG to the client-side license management device 106 and ends the process. When the result of Step A202 is OK, meaning that the network position check process determined that the client 11 and the server 10 are located in the same local area network and the license is available, the server-side license management device 101 continues the process (Step A203). More specifically, the server-side license management device 101 transmits the requested content and relevant license to the client-side license management device 106 (Step A204). Having determined from the network position check process in Step A202 that the client 11 and the server 10 are located in the same local area network, the server-side license management device 101 generates the vicinity check information in the license/vicinity check information issuing unit 104, and transmits the generated vicinity check information to the client-side license management device 106. The vicinity check information includes a requirement for authorizing omission of the network position check process for any request made by the client after the network position check process determined that the client 11 and the server 10 are located in the same local area network.

In the present exemplary embodiment, the vicinity check information is an information of network position check omission time length indicative of a length of time when the network position check process can be omitted after the network position check process determined that the client 11 and the server 10 are located in the same local area network, in other words, a duration of time indicative of how long from a current time point the network position check process can be omitted. The vicinity check information is set by the server 10 as far as a requirement for omitting the network position check process authorized by a content provider who distributed the content to the server 10 is met.

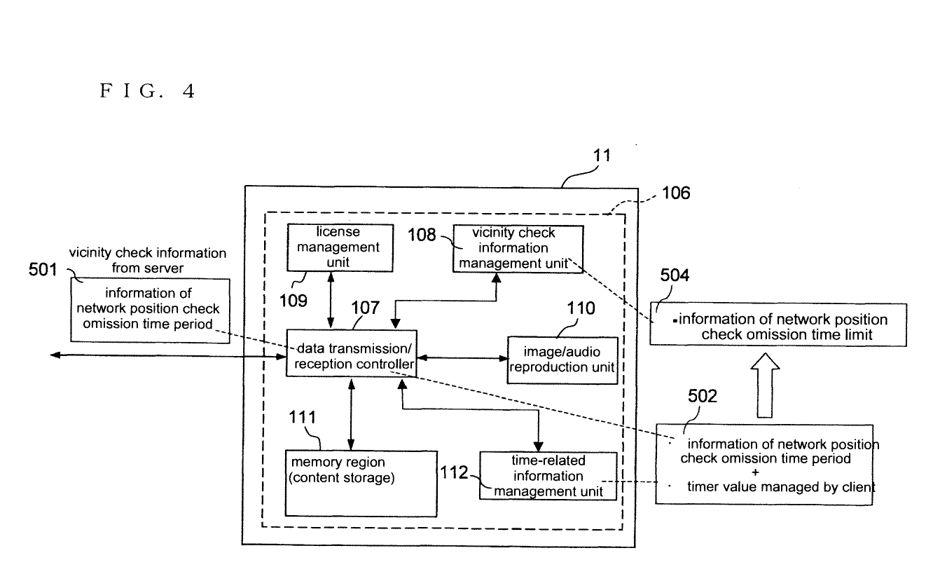

As illustrated in FIG. 4, the client-side license management device 106 stores an information 502, which is an information of network position check omission time length 501 received from the server-side license management device 101 plus the timer value managed by the time-related information management unit 112, to the vicinity check information management unit 108 as an information of network position check omission time limit 504 indicative of a time limit by which the network position check process can be thereafter omitted (Step A205). When the client starts to use the content obtained as described so far, the license management processing flow ends (Step A206).

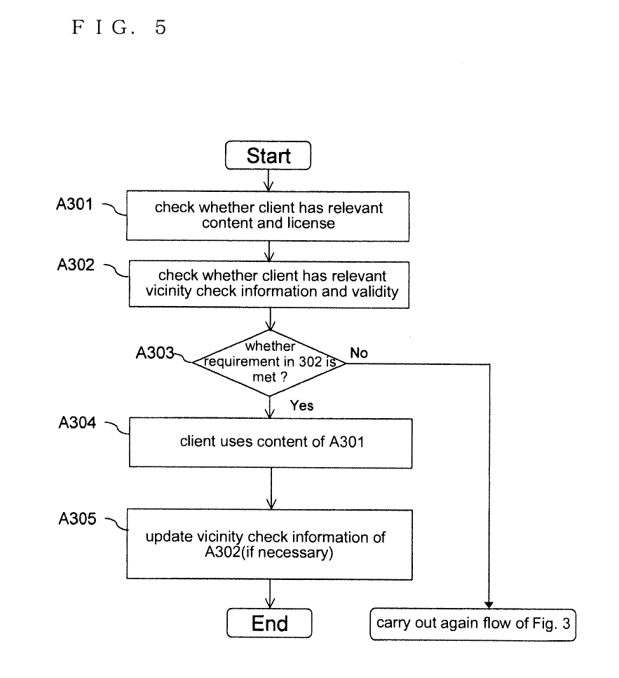

FIG. 5 is a processing flow of the license management system according to the exemplary embodiment 1 when the content already obtained by the client-side license management device 106 is used. In the client-side license management device 106, the license management unit 109 confirms whether any available content is stored in the memory region 111 and a relevant license meets the predefined license requirement (Step A301). The client-side license management device 106 checks whether the information of network position check omission time limit managed by the vicinity check information management unit 108 and the timer value managed and cyclically incremented in the time-related information management unit 112 stay within a value of the information of network position check omission time limit, briefly, whether or not the time value has reached the time limit by which the network position check process can be thereafter omitted (Step A302). The client-side license management device 106 determines the result of A302, and carries out the license management flow illustrated in FIG. 3 again when the result is NG (Step A303).

When the result of A303 is OK, the client-side license management device 106 uses the content confirmed in A301 in the image/audio reproduction unit 107 (Step A304). In the case where the vicinity check information currently used should be updated, the vicinity check information is updated and the updated information is stored in the vicinity check information management unit 108. Then, the license management processing flow by the client 11 when the content already obtained is used ends (Step A305).

As a result of the processing flow described so far, once the content, relevant license, and vicinity check information are obtained by the client 11, the client 11 can thereafter use the content without accessing the server 10 as far as the vicinity check information meets the requirement. When the client 11 currently located in the local area network is recognized by the server 10 as an authenticated access based on the received vicinity check information, the client 11 can use the content even after a user goes out with the client 11 to somewhere outside the local area network. Thus, the client can improve its friend-friendliness while respecting copyright protection.

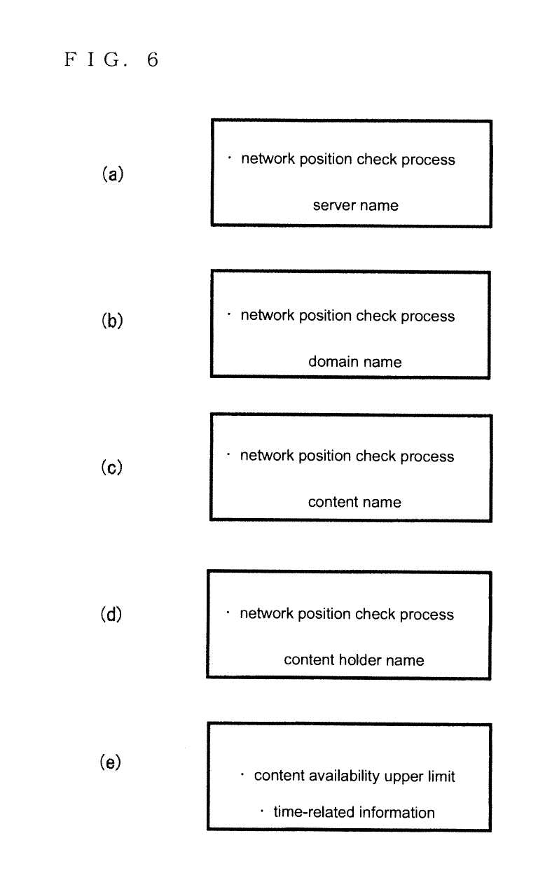

In the exemplary embodiment described so far, the vicinity check information is the time-related information indicative of the duration of time when the vicinity check for any access thereafter can be omitted. According to a modified embodiment, the time-related information may be combined with at least one of; name of a server which carries out the network position check process, name of a domain where the server which carries out the network position check process belongs, name of a content used after the network position check process, name of a holder of the content used after the network position check process, and an availability restriction for the content used after the network position check process as illustrated in a)-e) of FIG. 6.

By further using the server name as the vicinity check information, when the client communicates with a plurality of servers for the network position check process to be granted the content and relevant license, the duration of time when the network position check process can be thereafter omitted can be set by each of the servers.

By further using the domain name where the server belongs as the vicinity check information, the duration of time when the network position check process can be thereafter omitted can be set per domain. When the client communicates with a plurality of servers in the same domain for the network position check process, the client can update the vicinity check information by accessing an arbitrary one of the plurality of servers. In the case where the server or client domain changes after the vicinity check information is generated, availability of the vicinity check information can be restricted. By further using the content name as the vicinity check information, the duration of time when the network position check process can be thereafter omitted can be set per content used by the client. By further using the holder name as the vicinity check information, the duration of time when the network position check process can be thereafter omitted can be set per content holder. For example, the network position check process can be omitted for a content owned by a user over a larger length of time than any other content owned by his family member. By further using the content availability restriction as the vicinity check information, number of times in total when the network position check process can be thereafter omitted can be set.

As described so far, as far as the acquired content, relevant license, and the vicinity check information which is the information of network position check omission time limit 504 for authorizing omission of the network position check process and attendant information all meet the requirements, the client 11 can use the content without accessing the server 10.

### Exemplary Embodiment 2

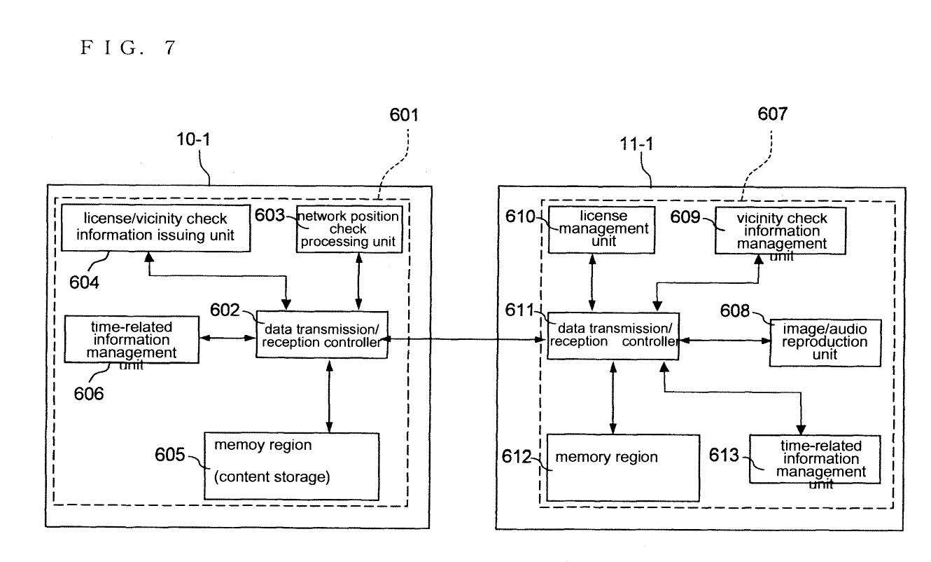

FIG. 7 is a block diagram illustrating main structural elements of a server 10-1 and a client 11-1 according to an exemplary embodiment 2 of the present invention, which are configured similarly to the illustration of FIG. 2. A server-side license management device 601 comprises a data transmission/reception controller 602, a network position check processing unit 603, and a memory region 605. These structural elements are structurally similar to the data transmission/reception controller 102, network position check processing unit 103, and memory region 105 of the server-side license management device 101 according to the exemplary embodiment 1.

A client-side license management device 607 comprises a data transmission/reception controller 611, a license management unit 610, an image/audio reproduction unit 608, and a memory region 612. These structural elements are structurally similar to the data transmission/reception controller 107, license management unit 109, image/audio reproduction unit 110, and memory region 111 of the client-side license management device 106 according to the exemplary embodiment 1.

A license/vicinity check information issuing unit 604 of the server-side license management device 601 is configured differently to the license/vicinity check information issuing unit 104 according to the exemplary embodiment 1. The license/vicinity check information issuing unit 604 issues a network position check omission start time and a network position check omission end time as the vicinity check information. The network position check omission start time is a start time of a duration of time when the network position check process can be omitted after the network position check process determined that the server and the client are located in the same local area network. The network position check omission end time is an end time of the duration of time.

A vicinity check information management unit 609 of the license management device 607 of the client 11-1 stores therein the network position check omission start time and the network position check omission end time used as the vicinity check information. Based on the stored information, the vicinity check information management unit 609 verifies the validity of the network position check process to determine whether a requirement for authorizing omission of the network position check process included in the stored vicinity check information is met when the content is used.

The license management device 601 of the server 10-1 and the license management device 607 of the client 11-1 respectively comprise a time-related information management unit 606 and a time-related information management unit 613 so that the other structural elements are notified of a current time point when they request so. The time-related information management unit 606 and the time-related information management unit 613 synchronize their time points.

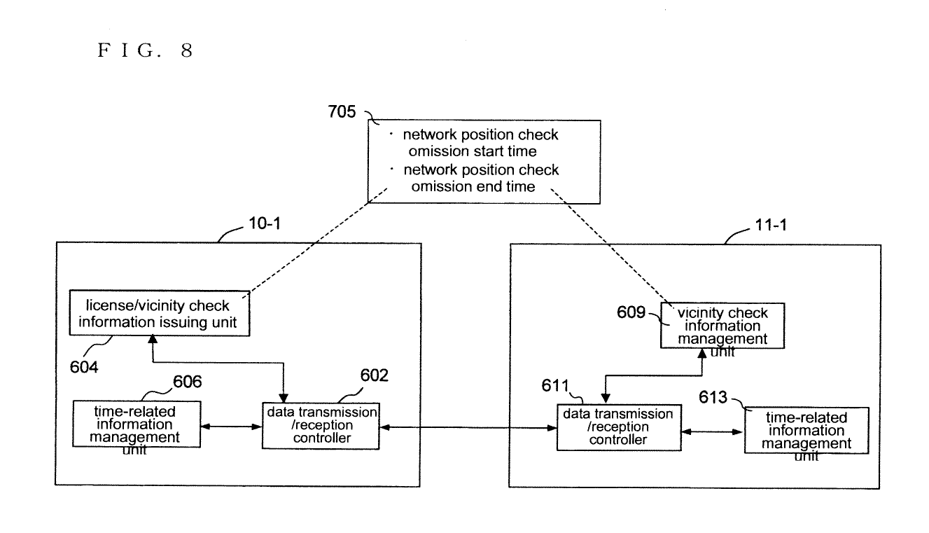

FIG. 8 illustrates a data flow when the vicinity check information is generated in the server 10-1 and retained in the client 11-1. A vicinity check information 705 is transmitted from the server-side license management device 601 to the client-side license management device 607. The vicinity check information 705 includes the network position check omission start time and the network position check omission end time. The vicinity check information 705 is generated in the license/vicinity check information issuing unit 604 based on the current time point obtained from the time-related information management unit 606 of the server-side license management device 601, transmitted to the client-side license management device 607, and managed by the vicinity check information management unit 609 of the client-side license management device 607. When the time point obtained by the time-related information management unit 613 of the client-side license management device 607 is included in the duration of time from the network position check omission start time till the network position check omission end time, the network position check process can be omitted. The network position check omission start time and the network position check omission end time are managed by the vicinity check information management unit 609 of the client-side license management device 607.

In the present exemplary embodiment, the network position check omission start time and the network position check omission end time are used as the vicinity check information to thereafter omit the network position conformation. Any other technical features are similar to those of the exemplary embodiment 1.

In the present exemplary embodiment, at least one of the server name, domain name, content name, content holder, and content availability restriction illustrated in FIGS. 6. a)-e) may be added to the vicinity check information similarly to the exemplary embodiment 1.

### Exemplary Embodiment 3

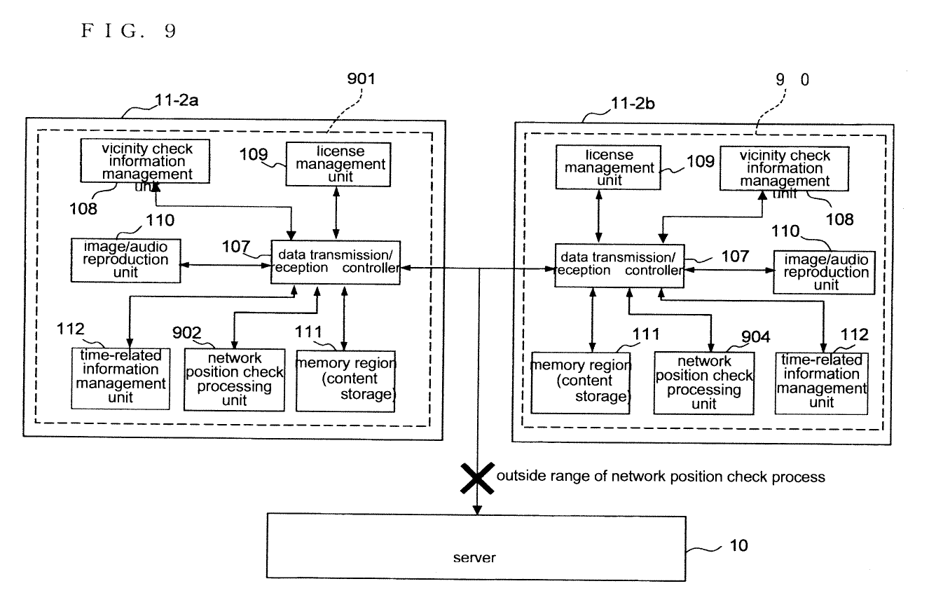

FIG. 9 is a block diagram of a server 10 and a plurality of clients 11-2a and 11-2b (two in the shown example) according to an exemplary embodiment 3 of the present invention. The server 10 is structurally similar to the server 10 according to the exemplary embodiment 1. A data transmission/reception controller 107, a vicinity check information management unit 108, a license management unit 109, a time-related information management unit 112, an image/audio reproduction unit 110, and a memory region 111 provided in each of license management devices 901 and 903 of the clients 11-2a and 11-2b are configured similarly to those of the license management devices 106 of the client 11 according to the exemplary embodiment 1.

The server 10 and the clients 11-2a and 11-2b according to the present exemplary embodiment respectively carry out the license management processing steps illustrated in FIGS. 3 and 5 according to the exemplary embodiment 1, thereby exerting an operational effect similar to that of the exemplary embodiment 1.

In the present exemplary embodiment, the license management devices 901 and 903 of the clients 11-2a and 11-2b respectively comprise a network position check processing unit 902 and a network position check processing unit 904 so that the vicinity check information can be updated between the clients 11-2a and 11-2b as well.

When the client 11-2a accesses the other client 11-2b, for example, while the clients 11-2a and 11-2b are not located in the same local area network as the server 10, the network position check processing unit 904 of the client 11-2b carries out the network position check process. When the network position check process confirms that the clients 11-2a and 11-2b both belong to the same local area network, the vicinity check information retained by the vicinity check information management unit 108 is granted to the client 11-2a. Thus, the vicinity check information retained by a client can be duplicated in another client so that the vicinity check information can be updated.

### Exemplary Embodiment 4

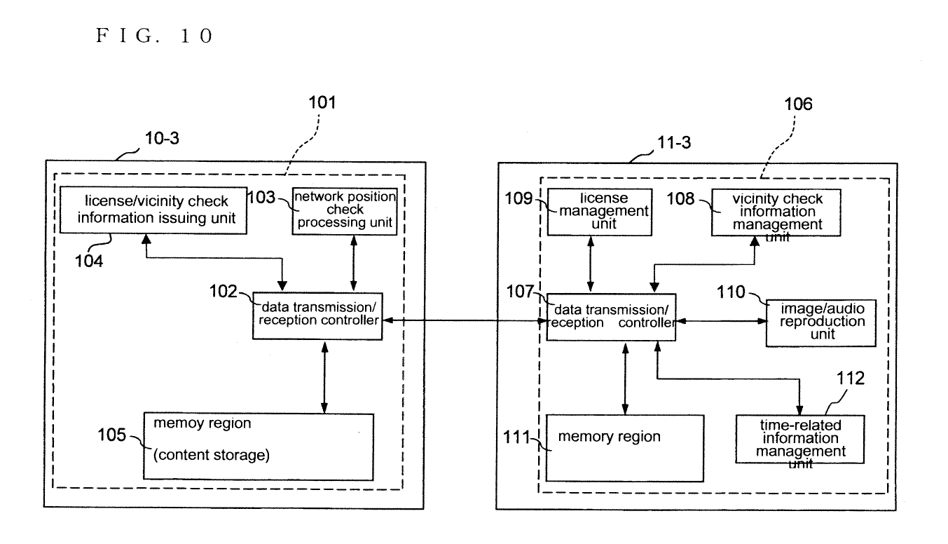

FIG. 10 is a block diagram illustrating main structural elements of a server 10-3 and a client 11-3 according to an exemplary embodiment 4 of the present invention, which are configured similarly to the illustration of FIG. 2.

A server-side license management device 101 comprises a data transmission/reception controller 102, a network position check processing unit 103, a license/vicinity check information issuing unit 104, and a memory region 105 used for content storage. These structural elements are configured similarly to those according to the exemplary embodiment 1.

A client-side license management device 106 comprises a data transmission/reception controller 107, a vicinity check information management unit 108, a license management unit 109, a time-related information management unit 112, an image/audio reproduction unit 110, and a memory region 1111. These structural elements are configured similarly to those according to the exemplary embodiment 1.

The server 10-3 and the client 11-3 according to the present exemplary embodiment respectively carry out the license management processing steps illustrated in FIGS. 3 and 5 according to the exemplary embodiment 1, thereby exerting an operational effect similar to that of the exemplary embodiment 1.

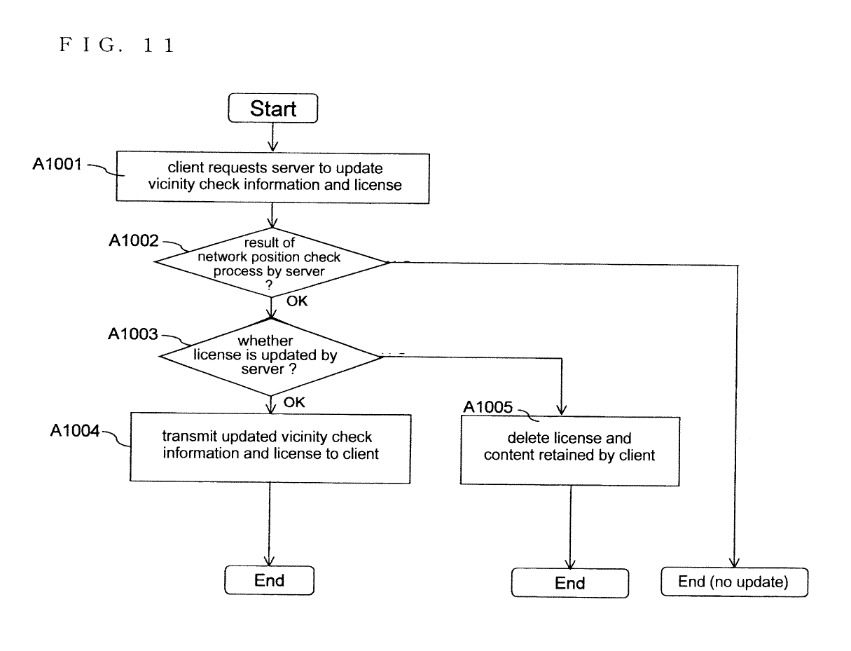

The present exemplary embodiment is further technically characterized in that an update process is carried out in accordance with a license management flow illustrated in FIG. 11. As illustrated in FIG. 11, the client-side license management device 106 requests the server-side license management device 101 to update the vicinity check information and the license (Step A1001). The server-side license management device 101 which received the request in Step A1001 carries out the network position check process for the client-side license management device 106. When the result of the network position check process is NG, the client-side license management device 101 ends the processing flow without the update process based on the confirmation that the client is temporarily outside the local area network. (Step A1002).

When the result of Step A1002 is OK, the server-side license management device 101 confirms the availability of the license of the client-side license management device 101 based on the license information thereby retained. After the availability of the license is confirmed, the server-side license management device 101 updates the vicinity check information and the license (Step A1003). When the result of A1003 is OK and the information and the license are updated, the updated vicinity check information and license are transmitted to the client-side license management device 106. Then, the processing flow ends (Step A1004).

When the result of A1003 is NG, it is determined that the server-side license management device 101 has no license which meets the requirement demanded by the client-side license management device 106. The client-side license management device 106 is then requested to delete the license and relevant content supplied thereto. Responding to the request, the client-side license management device 106 deletes the content and the license, and ends the processing flow (Step A1005).

As a result of the processing steps described so far, it is unnecessary to retransmit the content already retained by the client 11-3, and the content can be used as far as the license and the vicinity check information are updated. Because the content retransmission is thus unnecessary, the communication traffic can be reduced. The license and the content which are already deleted from the server 10-3 can be deleted from the client 11-3 by a timing of the update process.

### Exemplary Embodiment 5

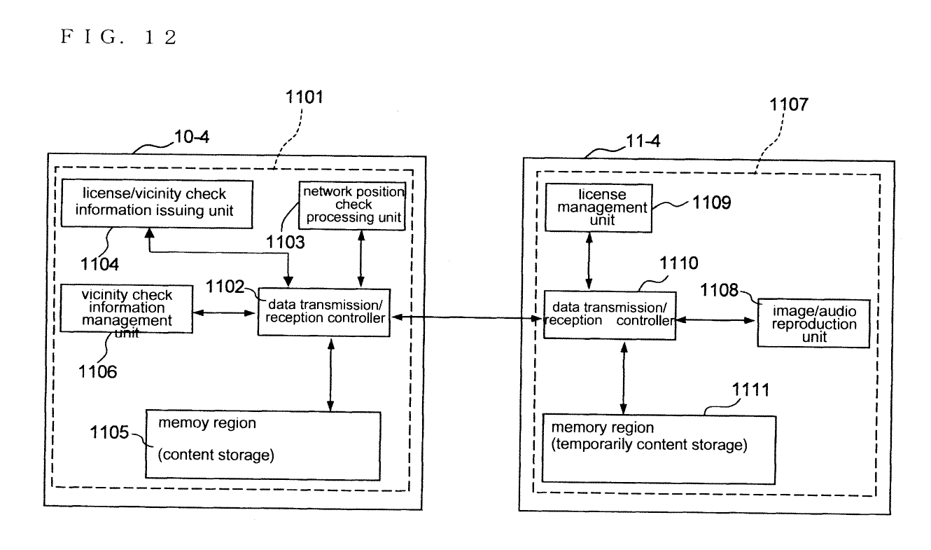

FIG. 12 is a block diagram illustrating main structural elements of a server 10-4 and a client 11-4 according to an exemplary embodiment 5 of the present invention, which are configured similarly to the illustration of FIG. 2. In the exemplary embodiments described so far, the vicinity check information generated by the servers 10, 10-1, and 10-3 are supplied to and stored in the clients 11, 11-1, 11-2a, 11-2b, and 11-3. The present exemplary embodiment is technically characterized in that the vicinity check information generated by the server 10-4 is not supplied to the client 11-4 but is retained by the server 10-4 per se. A more detailed description is given below.

A server-side license management device 1101 comprises a data transmission/reception controller 1102 which inputs and outputs the content and the license to and from a client-side license management device 1107, a network position check processing unit 1103 which carries out the network position check process to the client-side license management device 1107, a license/vicinity check information issuing unit 1104 which issues the vicinity check information and the license when the validity of the client-side license management device 1107 is confirmed, a memory region 1105 used for content storage, and a vicinity check information management unit 1106 which retains therein the vicinity check information.

The client-side license management device 1107 comprises a data transmission/reception controller 1110 which inputs and outputs the content and the license to and from the server-side license management device 1101, a license management unit 1109 which manages the license issued by the server-side license management device 1101, an image/audio reproduction unit 1108 which reproduces the content when the validity of the network position check process and the license is confirmed, and a memory region 1111 for storing therein the content supplied form the server side.

Next, main functions of the structural elements provided in the license management devices 1101 and 1107 illustrated in FIG. 12 are described below. The data transmission/reception controller 1102 of the server-side license management device 1101 is connected to the data transmission/reception controller 1110 of the client-side license management device 1107 to carry out various authentication processes to transmit and receive the content covered by domain management to and from the devices and also perform data transmission and reception. The communication performed then between the data transmission/reception controller 1102 and the data transmission/reception controller 1110 may be encrypted to improve a level of security. The network position check processing unit 1103, when requested by the client-side license management device 1107, carries out the network position check process and determines the process result. The license/vicinity check information issuing unit 1104 generates the license and the vicinity check information depending on the result of the network position check process. The vicinity check information management unit 1106 manages the vicinity check information generated by the license/vicinity check information issuing unit 1104, and uses the vicinity check information thereby managed whenever necessary when the client requests to use the content.

In the exemplary embodiments described so far, the vicinity check information includes the time-related information as the requirement for authorizing omission of the network position check process for any access thereafter. The requirement for authorizing omission of the network position check process for any access thereafter according to the present exemplary embodiment includes an information indicative of a client already supplied with the content and the license after the network position check process determined that the client is located in the local area network, for example, a client name. The license management unit 1109 of the client-side license management device 1107 stores therein the license supplied from the server-side license management device 1101, and confirms whether the stored license is available when the content is used.

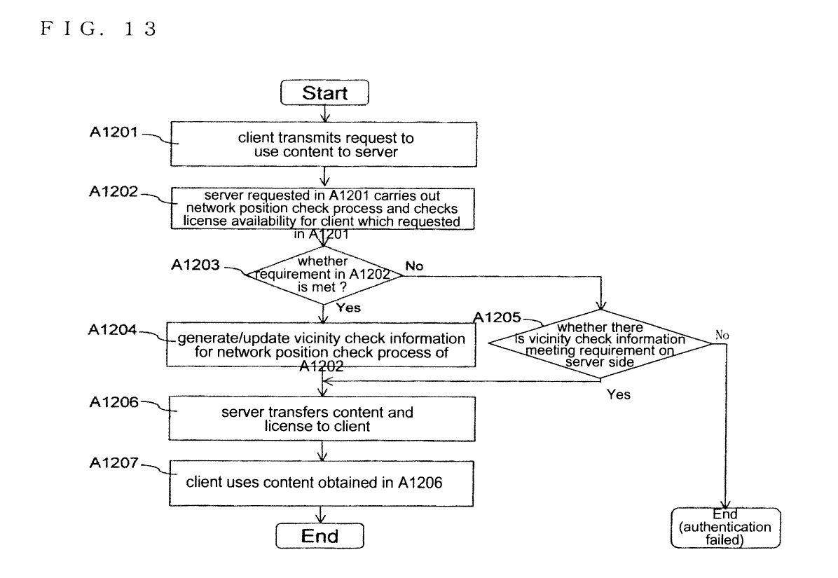

FIG. 13 is a processing flow of the license management system according to the present exemplary embodiment. The client-side license management device 1107 transmits a request for use of the content to the server-side license management device 1101 (Step A1201). The server-side license management device 1101 which received the request carries out the network position check process in order to determine whether the client-side license management device 1107 is located in the same local area network as the server and further belongs to the same domain as the server, and further verifies the validity of the license (Step A1202, A1203).

When the result of Step A1203 is OK, the vicinity check information is updated or the latest vicinity check information is generated (Step A1204). The vicinity check information generated or updated in this step includes a client name determined as OK in Step A1203 (client determined as being located in the local area network). The vicinity check information may include the content and the relevant license to be granted. After Step A1204, the server-side license management device 1101 transfers the content and the license to the memory region 1111 or the license management unit 1109 of the client-side license management device 1107 (Step A1206). The client-side license management device 1107 uses the content transferred thereto (Step A1207).

When the result of Step A1203 is NG, it is determined that the client-side license management device 1107 is located outside the local area network managed by the server-side license management device 1101. In the exemplary embodiment, the vicinity check information management unit 1106 determines in Step A1205 whether the client-side license management device 1107 meets the requirement of the vicinity check information retained by the vicinity check information management unit 1106. It is determined whether the name of the client which requested to use the content in the client-side license management device 1107 is included in the vicinity check information as a client already supplied with the content and the license after the network position check process determined that the client is located in the same local area network as the server.

Having determined that the name of the client which requested to use the content is included in the vicinity check information as a client already supplied with the content and the license, the network position check process can be omitted. Then, Step A1206 and steps thereafter can be carried out so that the content and the license can be supplied and used.

Similarly to the exemplary embodiments described earlier, the vicinity check information according to the present exemplary embodiment may include the time-related information as the requirement for authorizing omission of the network position check process in any access thereafter.

### INDUSTRIAL APPLICABILITY

When the present invention is applied to DRM-compliant digital devices, the benefit of a content provider can be protected without undermining a good user-friendliness. The present invention is applicable to such devices as digital television, HDD recorder, DVD recorder, digital audio player, mobile telephone, and personal computer.

### DESCRIPTION OF REFERENCE SYMBOLS

10, 10-1, 10-3, 10-4 server
11, 11-1, 11-2a, 11-2b, 11-3, 11-4 client
101, 601, 1101 server-side license management device
106, 607, 901, 903, 1107 client-side license management device
104, 604, 1104 license/vicinity check information issuing unit
103, 603, 1103 network position check processing unit
108, 609, 1106 vicinity check information management unit
102, 107, 602, 611, 1102, 1110 data transmission/reception controller
105, 111, 605, 612, 1105, 1111 memory region
109, 610, 1109 license management unit
110, 608, 1108 image/audio reproduction unit
112, 613 time-related information management unit

What is claimed is:

1. A license management system characterized in that a server supplies a client with a content and a license including a requirement for use of the content correspondingly with a request to use the content transmitted from the client through a communication line, wherein
the server carries out a network position check process for the client which requests to use the content, and the server generates a vicinity check information including a requirement for authorizing omission of the network position check process for the client when the client thereafter requests to use the content again after the network position check process determines that the client is located in a local area network where the server belongs, and
at least one of the server and the client retains the vicinity check information to determine based on the vicinity check information whether the network position check process can be omitted when the client thereafter requests to use the content again.

2. A license management system characterized in that a server supplies a client with a content and a license including a requirement for use of the content correspondingly with a request to use the content transmitted from the client through a communication line, wherein
the server carries out a network position check process for the client which requests to use the content, and the server supplies the client with the content, the license, and a vicinity check information including a requirement for authorizing omission of the network position check process for the client when the client thereafter requests to use the content again after the network position check process determines that the client is located in a local area network where the server belongs, and
the client retains the vicinity check information, the content, and the license, and determines based on the vicinity check information whether the network position check process can be omitted to use the content when the client thereafter requests to use the content again.

3. A license management system characterized in that a server supplies a client with a content and a license including a requirement for use of the content correspondingly with a request to use the content transmitted from the client through a communication line, wherein
the server carries out a network position check process for the client which requests to use the content, and the server supplies the client with the content and the license, and further generates and retains a vicinity check information including a requirement for authorizing omission of the network position check process for the client when the client thereafter requests to use the content again after the network position check process determines that the client is located in a local area network where the server belongs, and
the server determines based on the vicinity check information whether the network position check process can be omitted to supply the client with the content and the license when the client thereafter requests to use the content again.

4. A client used in a license management system characterized in that a server supplies a client with a content and a license including a requirement for use of the content correspondingly with a request to use the content transmitted from the client through a communication line, wherein the server carries out a network position check process for the client which requests to use the content, and the server supplies the client with the content, the license, and a vicinity check information including a requirement for authorizing omission of the network position check process for the client when the client thereafter requests to use the content again after the network position check process determines that the client is located in a local area network where the server belongs,
the client comprising:
a memory for storing the content;
a license management unit for retaining the license; and
a vicinity check information management unit for retaining the vicinity check information, and
the vicinity check information management unit determines based on the vicinity check information whether the network position check process can be omitted to use the content when the client thereafter requests to use the content again.

5. The client as claimed in claim 4, wherein
the vicinity check information management unit receives a latest vicinity check information by accessing the server on regular intervals to update the vicinity check information with the latest vicinity check information.

6. The client as claimed in claim 4, wherein
the vicinity check information includes a time-related information for specifying a time point when the client which requests to use the content is determined as being located in the local area network where the server belongs.

7. The client as claimed in claim 6, further comprising a measuring instrument for measuring time, wherein
the time-related information is an information of network position check omission time length indicative of a length of time when the network position check process can be thereafter omitted, and
the vicinity check information management unit calculates an information of network position check omission time limit indicative of a time limit by which the omission of the network position check process is thereafter authorized to use at least one of the content and the license based on a measured value obtained by the measuring instrument and the information of network position check omission time length.

8. The client as claimed in claim 6, further comprising a time-related information management unit in charge of time management in synchronization with a time-related information management unit of the server, wherein
the time-related information is a start time and an end time of a duration of time when the network position check process can be thereafter omitted, and
the vicinity check information management unit omits the network position check process to use at least one of the content and the license in the duration of time from the start time till the end time managed by the time-related information management unit.

9. The client as claimed in claim 4 which communicates with a plurality of the servers, wherein
the vicinity check information includes an information for identifying any of the servers which carries out the network position check process as a requirement for determining whether the network position check process can be thereafter omitted.

10. The client as claimed in claim 4, which communicates with a plurality of the servers, wherein
the vicinity check information includes an information for identifying a domain in the local area network where the server which carries out the network position check process belongs as a requirement for determining whether the network position check process can be thereafter omitted.

11. The client as claimed in claim 4, wherein
the vicinity check information includes an information for identifying the content as a requirement for determining whether the network position check process can be thereafter omitted.

12. The client as claimed in claim 4, wherein
the vicinity check information includes an information for identifying a user who owns the content as a requirement for determining whether the network position check process can be thereafter omitted.

13. The client as claimed in claim 4, wherein
the vicinity check information includes an information for setting an availability restriction for at least one of the content and the license as a requirement for determining whether the network position check process can be thereafter omitted

14. A license management system in claim 1, including a plurality of the clients,
wherein
when a first client which is one of the plurality of clients confirms correspondingly with an access made by a second client which is the other of the plurality of clients that the second client is located in a local area network where the first client is connected, the first client supplies the second client with the vicinity check information retained by the first client

15. The client as claimed in claim 4, wherein
the server checks whether the client is located in the local area network where the server belongs and whether the license is available to the client correspondingly with the vicinity check information and a request to update the license transmitted from the client, and the server supplies the client with the vicinity check information and an updated information of the license after the network position check process determines that the client is located in the local area network where the server belongs and the license is available to the client, and
the client updates the vicinity check information retained by the vicinity check information management unit and the license retained by the license management unit based on the updated information.

16. The client as claimed in claim 15, wherein
the server requests the client to deactivate any license and relevant content whenever the confirmation of the license availability fails, and the client deactivates the license and the content based on the request.

17. A server which carries out a network position check process for a client which transmits a request to use a content through a communication line to determine whether the client is located in a local area network where the server belongs, and
the server supplies the client with the content, a license including a requirement for use of the content, and a vicinity check information including a requirement for authorizing omission of the network position check process for the client when the client thereafter requests to use the content again after the network position check process determines that the client is located in the local area network.

18. A server which carries out a network position check process for a client which transmits a request to use a content through a communication line, and supplies the client with the content and a license including a requirement for use of the content after the network position check process determines that the client is located in a local area network where the server belongs,
the server further comprising a vicinity check information management unit for retaining a vicinity check information indicative of a client already supplied with the content and the license, and
the vicinity check information management unit determines based on the vicinity check information whether the client which requests to use the content is the client already supplied with the content and the license, and the vicinity check information management unit omits the network position check process for the client after determining that the client which requests to use the content is the client already supplied with the content and the license.

19. The server as claimed in claim 18, wherein
the vicinity check information includes time-related information for specifying a time point when the client which requests to use the content is determined as being located in the local area network where the server belongs.

20. A license management method comprising the following steps wherein:
a server carries out a network position check process for a client which transmits a request to use a content through a communication line to determine whether the client is located in a local area network where the server belongs;
the server supplies the client with the content, a license, and a vicinity check information including a requirement for authorizing omission of the network position check process for the client when the client thereafter requests to use the content again after the server determines that the client is located in the local area network;
the client retains the content, the license, and the vicinity check information and
the client determines based on the vicinity check information whether the network position check process can be omitted to use the content when the client thereafter requests to use the content again.
